(19) United States
(12) Patent Application Publication
(10) Pub. No.: US 2017/0374368 A1
(43) Pub. Date: Dec. 28, 2017

(54) Video Processor, Method, Computer Program

(71) Applicant: SCALAR CORPORATION, Tokyo (JP)

(72) Inventor: Masao Yamamoto, Tokyo (JP)

(21) Appl. No.: 15/191,802

(22) Filed: Jun. 24, 2016

(51) Int. Cl. H04N 19/146; H04N 5/232; H04N 19/70; H04N 19/42; H04N 7/15; H04N 7/18; H04N 101/00

(52) U.S. Cl. CPC H04N 19/146; H04N 19/70; H04N 5/23206; H04N 19/42; H04N 7/183; H04N 2101/00; H04N 7/15

(57) ABSTRACT

To provide a practical technique with which video data can be transmitted with a wireless LAN from a video output device having a function of processing video data to a terminal device having a display unit such as a mobile terminal.

A video output device 100 outputs video data via a line. A video processor 200 transmits compressed data obtained by JPEG-compressing data of the received video for each frame data to a terminal device 300 from a wireless LAN communication unit, from time to time. The terminal device 300 decompresses the compressed data to restore the frame data, and displays an image based on the video data on a display unit 301.

### TECHNICAL FIELD

The present application relates to techniques to wirelessly transmitting video data from a video output device having a function of outputting video data to a terminal device.

### BACKGROUND ART

As devices having a function of outputting video data, there exist digital video cameras. Video cameras create video data by shooting videos. Most video cameras store video data on their built-in storage medium. Furthermore, typical video cameras are capable of supplying video data to an external device at the same time as shooting or at an appropriate time after shooting, via a line.

When an external device has a display unit, this display unit of the external device can be used as a display unit (monitor) for the user to check videos taken with the video camera particularly when the video camera has no display unit. In such cases, a wireless connection between the external device and the video camera, if available, would be extremely convenient because it eliminates the bother of connecting the video camera and the external device with a cable, troubles associated with the cable itself, and restrictions on the positions of the video camera and the external device which otherwise occurs due to, for example, a limited length of cable.

In exemplified cases where the video camera is an endoscope camera, it is also possible to distribute an image captured by the endoscope to external devices held by two or more doctors in their hands.

Mobile terminals which have already become very popular can be used as an external device as described above. Examples of the mobile terminals include laptop computers, smartphones, and tablet computers. They are equipped with a display unit, and most of them are implemented with a function of wireless LAN.

Another example of the video output device includes computers such as laptop personal computers and tablet computers. If it is possible to reproduce an image displayed on the display unit of one laptop personal computer on the display unit of another laptop personal computer or other mobile terminal, it is convenient in the following exemplified cases.

In presentations at conferences, projectors are traditionally used. When making a presentation, a presenter projects a desired image onto a screen or the like from a projector connected to a laptop personal computer or the like. Audience attending the conference listens to and sees the presenter's presentation while watching the projected image(s). Here, it is convenient if it is possible to reproduce the image(s) displayed on the display unit of the laptop personal computer operated by the presenter on the display unit of mobile terminals held by listeners. This will eliminate the necessity of paper handouts, and make people who are sitting far from an image projected by the projector free from troubles in recognizing the image, especially when the image contains a small character or characters. The above is not only applied to presentations but also to other applications to, for example, deliver desired information to visitors watching a theater, a concert, or a sport game from a single laptop computer or the like. The mechanism as described above could be something like “a small-scaled simple version of a television broadcasting system,” and it could evoke completely new demands, if achieved.

Similar circumstances also exist in video conferencing. For a video conference, two or more conference sites are connected via a network such as the Internet, and images captured by a video camera at each site are delivered over the network to large display devices provided at the respective sites for display. A large display device provided at a conference site is, however, often hard to see for participants who are sitting far from it and participants who cannot get a good angle to see the display device. In such cases, reproduction of the images displayed on the large display devices at the conference sites, on the display unit of mobile terminals held by the participants, if possible, would be extremely convenient (which may make the large display devices unnecessary).

### SUMMARY OF THE INVENTION

### Problems to be Solved by the Invention

All of the above examples are systems that can be achieved by transmitting video data with a wireless LAN from a video output device having a function of outputting video data to a terminal device, such as a mobile terminal, having a display unit.

Some limitations, however, still exist in achieving this.

It is difficult to transmit typical video data at line speeds for existing wireless LANs. In order to solve this problem, there may be an approach in which the image quality is reduced to reduce the amount of data to be transmitted, and an approach in which a frame rate for videos is reduced to reduce the amount of data to be transmitted. All of these approaches are to achieve the transmission of video data by reducing the quality of videos, but in many cases, it is not acceptable to reduce the quality of videos.

A problem of a delay arises when a user attempts to transmit videos without reducing their quality. Transmission with a significant delay is almost impossible to be used for medical applications such as endoscopes, and can cause discomfort to the user even in other applications.

An object of the present invention is to provide a technique that allows transmission of video data with a wireless LAN from a video output device to a terminal device such as a mobile terminal having a display unit, and in particular, to provide a practical technique that can reduce problems associated with a delay time.

### Means to Solve the Problems

The present invention is a video processor used in combination with a video output device for outputting a video data via a line, the video data being a data of a video including a large number of frame data, each frame data being data of each of continuous sequence of frames.

The video processor includes receiving means for receiving a video data supplied from the video output device; compression means for executing a process of compressing data of each frame in the video data received by the receiving means into compressed data in a digital format; and output means for sequentially supplying the compressed data generated by the compression means to a transmission device having transmission means for transmitting the compressed data to a terminal device via communication with a wireless LAN.

The video processor of the present invention is used in combination with a video output device for outputting a video data via a line in which the video data includes a large number of frame data and each frame data is data of each of a continuous sequence of frames. In other words, the video output device itself can or cannot make outputs with a wireless LAN depending on cases. The video output device, however, does not perform any special processing as described below. The video processor thus interfaces the video output device and the terminal device and serves to achieve communications from the video output device to the terminal device with a wireless LAN.

Transmission of the video data from the video output device to the video processor is wired in consideration of the transfer speed of video data as well as in consideration of the fact that substantially all video output device can make outputs via a line.

The video processor includes the receiving means for receiving a video data supplied from the video output device. It also includes the compression means for executing a process of compressing data of each frame in the video data received by the receiving means into compressed data in a digital format. This video processor uses a compression technique in order to reduce the amount of data to be transmitted to the terminal device without lowering the image quality and frame rate, thereby reducing a delay of videos.

The compressed data is transmitted by the output means to the transmission device having the transmission means for transmitting the compressed data to the terminal device via communication with a wireless LAN. The transmission means of the transmission device transmits the compressed data received from the video processor to the terminal device. As a result, each terminal device can receive the compressed data with a small delay time and reproduce, on its own display unit, a video based on the video data, according to a frame data restored by decompressing the compressed data.

The video processor according to the present application may be formed as a single unit having the transmission device by including the transmission means. Such video processor itself can serve as an adhoc base station, and it is thus possible to establish a simple network without using other transmission device such as a wireless router.

The compression means may be configured to compress each of the frame data of the video data received by the receiving means into the compressed data using a standardized predetermined method. If the compression means uses a standardized compression method, the terminal device can decompress the compressed data using standardized software provided on the terminal device without installing any special software in the terminal device.

The compression means may be configured to compress each of the frame data of the video data received by the receiving means, as a single still image without any other processing. For example, according to the MPEG 4 standard, in order to compress frame data for a certain target frame, past two frames preceding the target frame and future two frames following the target frame are also referred to. If compression is performed using such a method, in compressing the frame data of the target frame, the compression means cannot start compression of the frame data of a certain target frame until it receives the frame data two frames after the target frame. This produces a delay of the length of two frames. On the other hand, if the compression means compresses the frame data into compressed data as a single still image, no delay will occur. Since such compression typically uses a lower compression rate than in the video compression such as MPEG 4, a longer time is required to transmit compressed data from the video processor to the terminal device with a wireless LAN, which can cause a problem of frame losses. If, however, the terminal devices are only mobile terminal devices (such as smartphones or tablet computers), or if it is expected that most of the terminal devices are mobile terminal devices, or if at least a mobile terminal device is included, image resolutions required for viewing videos on a display unit of the mobile terminal device are at most about 4 K or at most about 8 K. There is no possibility that an extremely high resolution is required. If the frame rate is lower than about 60 fps, in particular, if the frame rate is about 30 fps, it is not difficult to transmit compressed data from the video processor to the terminal device(s) the a wireless LAN, even when the transmission is broadcast transmission.

If the compression means compresses a frame data of a certain frame without using the frame data of the subsequent frame(s) following that frame for the compression of that frame, in other words, if the compression means compresses a frame data of a certain frame using the frame data of that frame alone or only the frame data of the frame and the frame data of the preceding frame(s) for the compression of that frame, the aforementioned problem of a delay does not occur.

When the compression as described above is performed to compress each of the frame data into the compressed data as a single still image without any other processing, the compression means may be configured to perform, for example, JPEG compression.

When the compression means is configured to compress each of the frame data of the video data received by the receiving means into the compressed data as a single still image without any other processing, the compression means may be configured to compress a portion of the frame data in the order of being received from the receiving means. If the compression means starts compression after all the frame data have been received, a time period elapsing until the compression means has read all of the frame data becomes a delay. For example, in compressing a certain frame data by the compression means, if frame data is compressed 10 times in 1/10 steps each time 1/10 of the frame data is read, it becomes possible to reduce the delay time, though the delay time cannot be reduced to 1/10 because it depends on the amount of time required for compression. By dividing the frame data into portions and compressing them as received by the compression means, the delay time associated with the compression performed by the compression means can be reduced.

The compression means may be configured to compress the frame data of the video data received by the receiving means into the compressed data by using at least one of frame data preceding the frame data to be compressed and frame data following the frame data to be compressed.

As described above, the compression by the compression means can be performed by using the frame data before or after the frame data to be compressed. This is typical for MPEG compression, and by using such a compression method, it is possible to increase the compression rate for video data. If such a compression method is used, in particular, when frame data after the frame data to be compressed is used for compression, a delay of data by the time necessary for reading the subsequent frame data occurs. If, however, the compression rate is large, it is possible to shorten the time required for transmission of compressed data with a wireless LAN. If an effect obtained by the reduction of the transmission time is better than an effect obtained by the reduction of the time required for reading the frame data, this is also a useful technique for overcoming a delay of data.

When the compression means compresses the frame data of the video data received by the receiving means into the compressed data by using at least one of frame data preceding the frame data to be compressed and frame data following the frame data to be compressed, the compression means may be configured to perform MPEG compression.

The compression means may be configured to complete the process of compressing the frame data into the compressed data before the expiration of 200 ms after the receiving means has received the frame data.

In particular, when the present invention is used in the medical field such as cases where videos captured by an endoscope are distributed to a terminal device and a physician or the like examines the videos displayed on the display unit of the terminal device in substantially real time, a delay of 200 ms or more for the videos will prevent the physician or the like from performing accurate diagnosis, treatment, surgery, etc. This restriction in the medical field seems to be more stringent than in other fields.

If the compression means compresses the frame data into the compressed data within a limited time as described above, users who use the terminal devices will not be frustrated by the delay of videos, even in non-medical fields.

The compression means may be configured to complete the process of compressing the frame data into the compressed data before the expiration of 100 ms after the receiving means has received the frame data.

According to the studies made by the present inventor, a delay of videos is preferably within 100 ms to allow a physician to perform accurate diagnosis, treatment, surgery, etc. When the compression means compresses the frame data into the compressed data with a delay of within 100 ms, users who use the terminal devices will not be frustrated by the delay of videos, even in non-medical fields.

The compression means may be configured to complete the process of compressing a target frame data into the compressed data before the receiving means starts to receive a frame data incoming three frame data later than the target frame data.

Similar to the above cases, this also brings about a result that users who use the terminal devices will not be frustrated by the delay of videos.

When the transmission means is provided, the transmission means of the video processor of the present invention may be configured to transmit the compressed data to the terminal device using UDP (User Datagram Protocol)/IP protocol.

The present invention is highly compatible with techniques using UDP when transmitting data from the video processor to the terminal device(s). Unlike TCP (Transmission Control Protocol) which is a well-known communication protocol, UDP is a protocol that enables one-to-many communication, rather than one-to-one, from a transmitting device to a terminal device. In the case of “small-scale television broadcasting” including presentations, video conferences, and when two or more physicians share video(s) from an endoscope, the one-to-many communication of UDP/IP is very useful. This protocol does not perform so-called shake hand between a transmitter and a receiver, and has a feature of a high communication speed. This is suited for transmitting compressed data from the video processor to the terminal device(s) even though the capacity is reduced by compression.

If, however, only the one-to-one communication is required, the transmission means of the video processor may perform communications using TCP/IP. Unlike communications using UDP/IP, communications using TCP/IP do not omit acknowledgment, so data integrity is guaranteed.

When the transmission means transmits the compressed data using the UDP/IP protocol, the transmission means may have a setting of “255.255.255.255” as a destination IP address of the terminal device. For example, when communication is made using the UDP/IP protocol with the Wi-Fi (trade mark) standard, 253 computers (when 8-bit data is used for identification data) or 65,533 computers (when 16-bit data is used for identification data) are communicated wirelessly at the same time, according to the default of the standard. On the other hand, the present inventor found that the number of terminal devices on the receiving side can be unlimited or infinite if the destination IP address of the terminal device is set as described above. By using such setting, it is possible to eliminate the limitation on the number of terminal devices, and it is possible to eliminate a problem associated with the setting of an IP address for each terminal device.

The IP address in this case may be determined from the time of shipment of the video processor or may be set by a user of the video processor. In the latter case, means for making an input for enabling the user of the video processor to set the IP address may be provided in the video processor.

When transmission means is provided, the transmission means of the video processor according to the present invention may be configured to arbitrarily set a port number for specifying software to process the compressed data received by the terminal device from software installed on the terminal device. In that case, the video processor may include port number input means for inputting information to set the port number, and may be configured such that only the terminal device for which the same port number set on the transmission means has been set is able to display a video based on the received compressed data.

The compressed data transmitted from the video processor to the terminal device is decompressed and restored to the frame data, and a video based on the frame data is displayed on the display unit of the terminal device. In order to cause the display unit of the terminal device to display the video, it is necessary for the terminal device to select software to perform a series of processes after the decompression of the compressed data in the terminal device. This selection is typically specified by a number called a port number regardless whether the transmission of the compressed data is performed using UDP/IP or TCP/IP. If such a number can be arbitrarily set in the video processor, it becomes possible to let the terminal device automatically execute a series of processes after the decompression of the compressed data. At the same time, making it possible to set the port number in the video processor also makes it possible to allow only a certain terminal device to display videos on its display unit. In other words, in the video processor, if a certain port number is set for transmitting the compressed data, the port number is notified to each user having the terminal device, for example, verbally or visually or by transmission of e-mail, and each user has set the port number of its own terminal device to software for performing a series of processes after the decompression of the compressed data, a video based on the compressed data transmitted from the video processor is displayed only on the terminal device of the user who has performed such settings. The setting of the port number can thus be useful for security purposes. In particular, when the compressed data is transmitted to an unspecified number of terminal devices using UDP/IP, this technique that makes it possible to select a terminal device that is allowed to view a video and a terminal device on which a video cannot be viewed is highly useful.

The compression means may be configured to generate the compressed data as having header information and be able to transform at least a portion of the header information according to a certain algorithm. In this case, only the terminal device being able to perform inversion of the transformation of the header information may be able to display a video based on the received compressed data.

As described above, by using the port number, it is possible to selectively determine a terminal device that is allowed to display a video based on the compressed data on its display unit and a terminal device that cannot display the video on its display unit. This technique, however, forces the user to set the port number for the terminal device that he or she uses.

On the other hand, the technique as described above in which the compression means transforms at least a part of the header information and only the terminal device that can perform inverse transformation of the header information can display the video based on the received compressed data is also a technique to selectively determine the terminal device(s) allowed to display videos. With this, however, only the terminal devices on which software for performing the inverse transformation is installed as, for example, a part of software for performing a series of processes after decompression of the compressed data can display the video based on the compressed data. This technique makes it possible to allow, when compressed data is transmitted by a video processor sold by Company A, a terminal device on which software distributed by Company A (in many cases, so-called viewer software) for performing a series of processes after the aforementioned decompression of compressed data has been installed can display the video based on the compressed data and prevent another terminal device on which software distributed by Company B for performing a series of processes after the aforementioned decompression of compressed data has been installed from displaying the video based on the compressed data.

The video processor according to the present application may include modification means for modifying the frame data in such a manner that at least one of a certain character, symbol, and glyph is overlapped with an image represented by the frame data.

As described above, videos based on the compressed data transmitted by the video processor of the present application can be recorded in the terminal device in some cases. The recorded video or still image captured from the video can be distributed over, for example, the Internet. By displaying at least one of the characters, symbols, and glyphs as described above on the image displayed by the frame data, such as displaying a character or the like indicating that the video or the still image is protected by copyright of a certain person, it becomes possible to prevent illegal distributions of the recorded video or still image.

It should be noted that addition of such characters is not necessarily performed by the video processor. Instead, it may be performed on the terminal device. To make it possible, the following method may be used. Specifically, the video processor may include instruction addition means, the instruction addition means adding modification instruction data to the compressed data transmitted from the transmission means to the terminal device and allowing the transmission means to transmit the compressed data, the modification instruction data being for causing the terminal device to execute a process of modifying the frame data in such a manner that at least one of a certain character, symbol, and glyph is overlapped with an image represented by the frame data.

With the following method, it is also possible to obtain effects similar to those obtained in the video processor of the present invention.

An exemplified method is a video processing method executed on a video processor used in combination with a video output device for outputting a video data via a line, the video processor including a computer, the video data being a data of a video comprising a large number of frame data, each frame data being data of each of continuous sequence of frames.

This method includes performing, with the computer: a receiving operation for receiving the video data outputted from the video output device; a compression operation for compressing data of each frame in the video data received by the receiving operation into compressed data in a digital format; and an output operation for sequentially outputting the compressed data generated by the compression operation to a transmission device having transmission means, the transmission means transmitting the compressed data to a terminal device via communication with a wireless LAN.

With a computer obtained by installing the following computer program such as a general-purpose computer, it is also possible to obtain effects similar to those obtained in the video processor of the present invention.

An exemplified computer program is a computer program causing the computer to function as a video processor used in combination with a video output device for outputting a video data via a line, the video processor including a computer, the video data being a data of a video comprising a large number of frame data, each frame data being data of each of continuous sequence of frames.

This computer program causes the computer to execute: a receiving operation for receiving the video data supplied from the video output device; a compression operation for compressing data of each frame in the video data received by the receiving operation into compressed data in a digital format; and an output operation for sequentially outputting the compressed data generated by the compression operation to a transmission device having transmission means, the transmission means transmitting the compressed data to a terminal device via communication with a wireless LAN.

### BRIEF DESCRIPTION OF THE DRAWINGS

FIG. 1 is a view schematically showing a communication system according to a first embodiment;

FIG. 2 is a view showing a hardware configuration of a video processor included in the communication system shown in FIG. 1;

FIG. 3 is a block diagram showing a functional block generated inside the video processor included in the communication system shown in FIG. 1;

FIG. 4 is a view schematically showing an exemplified compression process executed in the communication system shown in FIG. 1;

FIG. 5 is a view showing a hardware configuration of a terminal device included in the communication system shown in FIG. 1;

FIG. 6 is a block diagram showing a functional block generated inside the terminal device included in the communication system shown in FIG. 1; and

FIG. 7 is a view schematically showing a communication system according to a second embodiment.

### MODES FOR CARRYING OUT THE INVENTION

First and second embodiments of the present invention are described below.

In the description of these embodiments, similar components are depicted by similar reference numerals, and redundant description will be omitted in some cases.

### First Embodiment

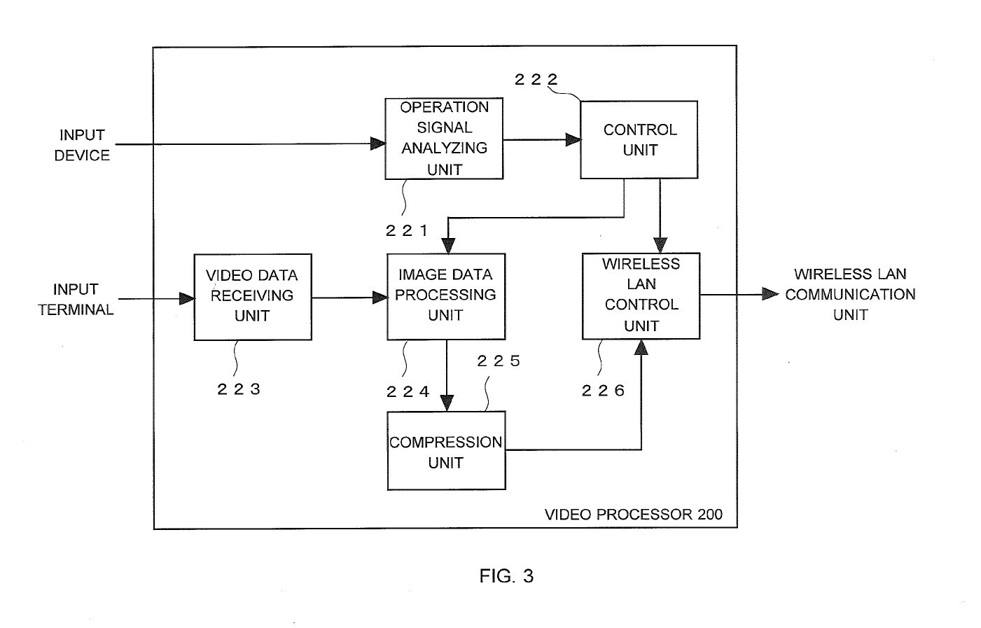

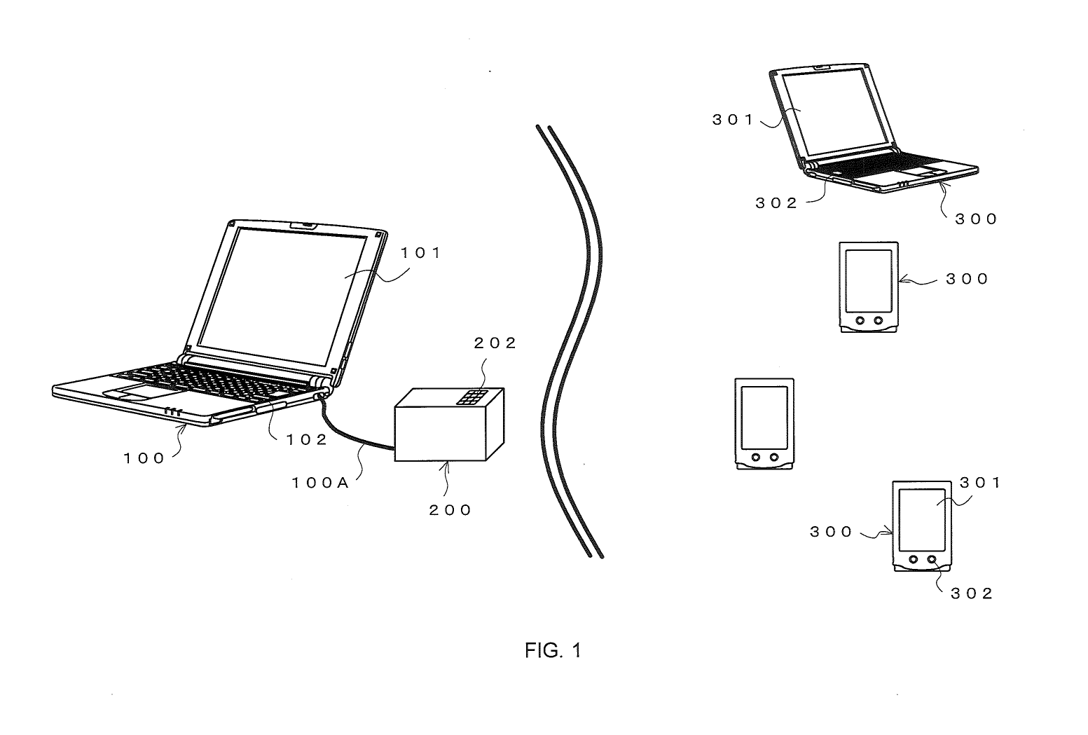

In this embodiment, a communication system including a video output device, a video processor according to the present invention, and a terminal device adapted to receive compressed data described later from the video processor is described. FIG. 1 schematically shows the communication system of this embodiment.

The communication system is configured with a video output device 100, a video processor 200, and a terminal device or devices 300.

The video output device 100 is a device for outputting video data via a line. The video output device 100 may be any one of devices as long as it can achieve this operation.

For example, the video output device 100 may be a video camera (e.g., a video camera for shooting videos for television broadcasting and a video camera built in an endoscope are the examples) capable of outputting video data for a captured video at the same time as shooting, an apparatus of a video conference system capable of receiving video data from a remote site and typically supplying the video data to a large display device at a local site, a laptop or desktop computer, or a tablet computer such as iPad (trademark) sold by Apple Japan.

In a first embodiment, the video output device 100 is a computer, more specifically, a laptop computer. The communication system in this embodiment is, but not limited to, a presentation system used for presentations at a conference.

The video output device 100 and the video processor 200 are operated by a presenter (or his or her assistant, the same applies hereinafter) for making a presentation, and the terminal devices 300 are controlled by participants. The terminal devices 300 may be personal belongings of the participants or may be distributed or lent to the participants by a presenter or a collaborator of the presenter.

The terminal device 300 needs to be able to perform communication with a wireless LAN. The terminal device 300 has a display unit and is preferably portable. The terminal device 300 may be a smartphone, a tablet computer or a laptop computer. Examples of the tablet computers are as described for the video output device 100, and the smartphone is, for example, an iPhone which is manufactured and sold by Apple Japan. This embodiment exemplifies a case where the communication system is a presentation system and thus more than one terminal device 300 is expected to be associated with. It is, however, not necessarily required that there are two or more terminal devices 300.

The description of the video output device 100 is now continued.

The video output device 100 is a laptop computer having a display unit 101. The hardware configuration and the installed computer program(s) can be those known in the art. The video output device 100 also includes an input device 102. The input device 102 of this embodiment is a keyboard, but in addition or alternative to this, another input device such as a trackball, a mouse, and a touch panel may be provided in the video output device 100. The video output device 100 has an output terminal which is not shown. The output terminal may be any known output terminal. The output terminal is capable of outputting video data.

The output terminal may output video data as an analog signal or as a digital signal. Analog RGB terminals are examples for the former case and HDMI terminals and thunder bolt terminals are examples for the latter case.

The video output device 100 is equipped with known presentation software so that presentations can be performed. Examples of the presentation software include PowerPoint (trademark) manufactured by Japan Microsoft Corporation. An image used for presentation is reproduced on the display unit 101, and the presenter performs his or her presentation while watching it.

Next, the video processor 200 is described.

The video processor 200 is connected to the video output device 100 and has a function of compressing the video data received from the video output device 100 and transmitting the compressed video data to each of the terminal devices 300. As a result, the image that is substantially the same as the one displayed on the display unit 101 of the video output device 100 is reproduced on the display unit of the terminal device 300 as described later.

The video processor 200 is a computer. The video processor 200 also has an input device 202. Although the input device 202 of this embodiment is a ten-key pad, a keyboard, a mouse or a touch panel can be used as the input device 202.

The video processor 200 includes an input terminal which is not shown. The input terminal is paired with the output terminal of the video output device 100 and receives the video data supplied from the output terminal. The input terminal is connected to the output terminal of the video output device 100 via a line. A cable 100A connects the input terminal and the output terminal.

In addition, the video processor 200 implements a function of the wireless LAN. The function of the wireless LAN is achieved by a wireless LAN communication unit with an antenna, which is not shown. As will be described later, the wireless LAN communication unit is controlled by a wireless LAN control unit, and performs communication with the terminal device 300 with a wireless LAN. The wireless LAN communication unit of this embodiment may be a known wireless LAN communication unit capable of performing Wi-Fi communication.

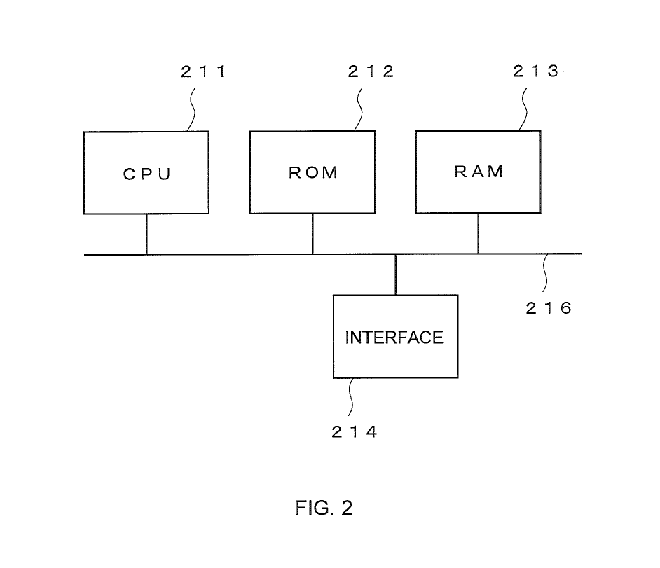

The video processor 200 has a hardware configuration as shown in FIG. 2.

This hardware configuration includes a CPU 211, a ROM 212, a RAM 213, and an interface 214, which are connected to each other via a bus 216.

The CPU 211 is an arithmetic unit that performs arithmetic operations. The CPU 211 executes a processing which is described later by executing, for example, a computer program stored in the ROM 212. The computer program herein includes at least a computer program for allowing the video processor 200 to function as the video processor of the present invention. This computer program may be preinstalled in the video processor 200 or may be installed afterwards. Installation of this computer program in the video processor 200 may be performed via a predetermined storage medium such as a memory card or via a communication line such as a LAN or the Internet.

The ROM 212 stores computer programs and data necessary for the CPU 211 to execute processing described later.

The RAM 213 provides a work area necessary for the CPU 211 to perform processing. A part of the RAM 213 serves as a frame buffer described later.

The interface 214 allows the CPU 211, the RAM 213, etc. connected via the bus 216 to send and receive data to and from the outside. The interface 214 is connected to the aforementioned input device 202, an input terminal which is not shown, and the aforementioned wireless LAN communication unit. A user input from the input device 202 and the input from the input terminal are supplied to the bus 216 through the interface 214 and the compressed data described later supplied from the interface 214 to the wireless LAN communication unit is supplied from the wireless LAN communication unit to the terminal device 300.

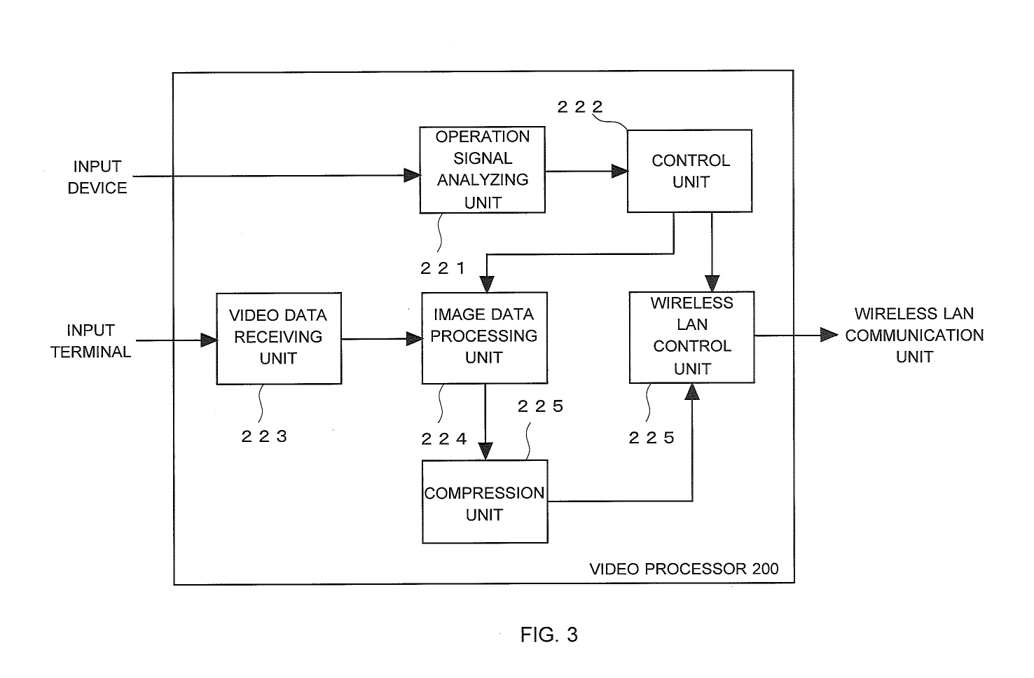

When the CPU 211 executes a computer program, a function block as shown in FIG. 3 is generated inside the video processor 200. It should be noted that the following functional blocks may be generated by the aforementioned computer program alone, but may be generated by the aforementioned computer program in cooperation with the operating system or other computer program run on the video processor 200. Furthermore, at least a part of the process performed in the following functional blocks may be executed by hardware, not by a computer program.

An operation signal analyzing unit 221, a control unit 222, a video data receiving unit 223, an image data processing unit 224, a compression unit 225, and a wireless LAN control unit 226 are generated inside the video processor 200.

The operation signal analyzing unit 221 analyzes an operation signal supplied from the input device 202. In this embodiment, from the input device 202, numerical values are entered as information for setting an IP address and a port number described later. When an operation signal associated with the numerical values is entered from the input device 202, the operation signal analyzing unit 221 analyzes a numerical value designated by the operation signal. The result of the analysis by the operation signal analyzing unit 221, that is, the numerical value is transmitted to the control unit 222. Note that the information on the numerical value may be provided from the input device 102 of the video output device 100 rather than from the input device 202.

The operation signal analyzing unit 221 is also provided with an operation signal for character/symbol information from the input device 202. The character/symbol information is for determining whether the data on at least one of characters, symbols, and glyphs (hereinafter, sometimes collectively referred to as a “character”) described later is to be included in the frame data or for determining which characters are included in the frame data if the characters are included in frame data described later. In response to the reception of the operation signal for the character/symbol information, the operation signal analyzing unit 221 analyzes it and sends it to the control unit 222.

The control unit 222 transmits necessary data to the image data processing unit 224 and the wireless LAN control unit 226. Specifically, the control unit 222 transmits, to the image data processing unit 224, what is specified by the character/symbol information received from the operation signal analyzing unit 221, i.e., information for determining whether at least one of characters, symbols, and glyphs is to be included in the frame data or for determining which at least one character, symbol, or glyph is included in the frame data if the character, symbol, or glyph is included in frame data. Furthermore, the control unit 222 transmits numerical values for identifying an IP address and a port number received from the operation signal analyzing unit 221 to the wireless LAN control unit 226.

It should be noted that the control unit 222 may use, as the port number, a numerical value itself entered with the input device 202 or a numerical value determined after a predetermined arithmetic operation is performed on the entered numerical value. In this embodiment, the latter is used but not limited thereto.

To the video data receiving unit 223, the video data received by the input terminal is entered via the interface 214. The video data is a sequence of consecutive frame data for identifying individual frames. If the frame rate for videos is, for example, 60 fps, the frame data are received by the video data receiving unit 223 at 60 times per second. The video data receiving unit 223 transmits the frame data to the image data processing unit 224, every time when it receives the frame data.

The image data processing unit 224 executes necessary image processing on the frame data.

The image processing executed by the image data processing unit 224 is as follows.

First, when the frame data is an analog signal, the image data processing unit 224 converts it into a digital signal.

Furthermore, when the frame data is the compressed one, the image data processing unit 224 decompresses it. For example, some recent digital video cameras are capable of outputting compressed MPEG images via a line. If the video output device 100 is for outputting such compressed frame data, the image data processing unit 224 decompresses that frame data.

The image data processing unit 224 also receives the data on the character/symbol information from the control unit 222. When the information indicates to add at least one character, symbol, and glyph of “XXXX (any character(s) or symbol(s))” to the frame data, the image data processing unit 224 executes an appropriate processing for the frame data. More specifically, a process is executed to incorporate the character(s) “XXXX” into the frame data or frames for the frame data, i.e., basically all frame data. In this embodiment, the characters are static and shared by all frame data. The characters to be added in this embodiment are for indicating that the original video data is protected by copyright, but not limited thereto. For example, the characters can be “this video is protected by copyright,” “author Yamamoto,” a combination of characters and a symbol such as “(c) YAMAMOTO,” a corporate logo mark or other pattern protected by copyright or a combination of a pattern and letters indicating the corporate name, and the like.

The process of adding a character or characters to each frame data can be executed according to, for example, the following 1 to 3.
1. The frame data is compressed as described later, but in the previous state, the frame data is expanded on an image memory such as RGB or YUV (which may be a part of the aforementioned RAM 213). The aforementioned object can be achieved by overwriting, every time the frame data is expanded on the image memory, the character(s) in, for example, the BMP (Microsoft Windows Bitmap Image: “Microsoft” and “Windows” are both trademarks) format previously loaded, to the frame or image provided by the frame data in question.
2. If an alpha channel of a layer that is different from the frame or image expanded in the image memory is present in the image memory as described above, and if the character(s) has/have been written in that alpha channel, then the character(s) is/are automatically added to a subsequent frame or image when it is expanded in the image memory.
3. If an integrated circuit that can be configured by a purchaser or a designer after the production of FPGA (field-programmable gate array) or the like is present ahead of the image memory, the aforementioned object can be achieved by keeping the data of the character(s) in the FPGA and overlaying the data of the character(s) directly on the frame data passing through the FPGA.

When the image data processing unit 224 finishes image processing, the processed frame data is sequentially transmitted to the compression unit 225.

The compression unit 225 sequentially compresses each frame data received from the image data processing unit 224. The compression method may be a known method such as a standardized method. Compressed frame data is compressed data.

The compression unit 225 may compress each of the frame data into the compressed data as a single still image without any other processing. An example of such compression is, for example, JPEG compression.

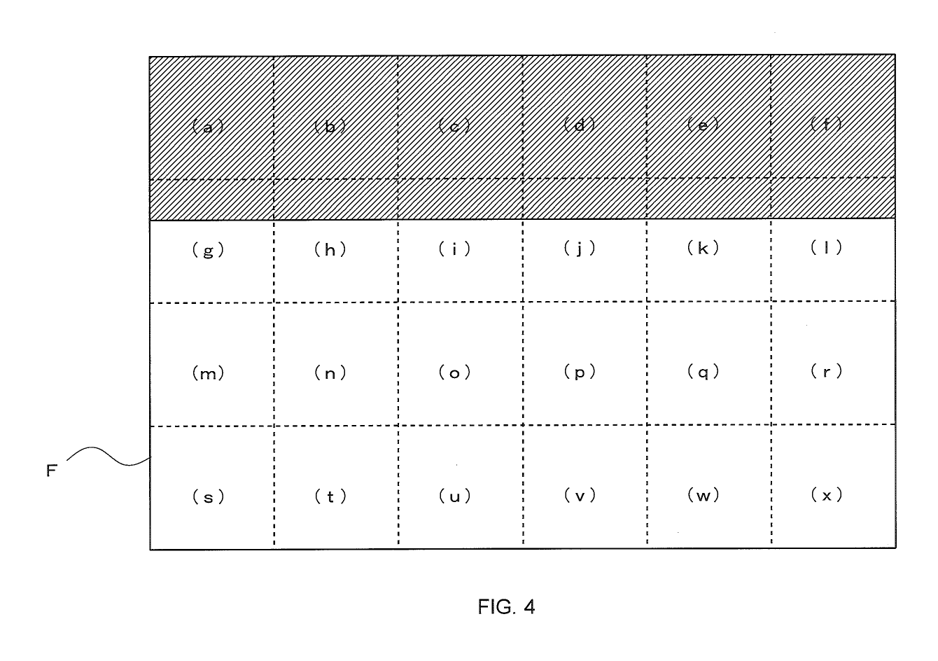

When the compression unit 225 compresses each of the frame data as a single still image, the compression unit 225 may be configured to compress a portion of the frame data in the order of being received from the image data processing unit 224. A frame data is typically read in the following order: the top row of a frame is read from left to right, then the second row under the top is read from left to right, . . . the bottom row is read from left to right. For example, in the example of FIG. 4, it is assumed that a portion of a frame data for a frame F corresponding to the hatched range has already been read, that is, the data has been received by the compression unit 225. The frame data (more precisely, a portion of the frame data) has already been read for zones (a) to (f) of zones (a) to (x) making up the frame F, so that compression can be performed prior to the compression of other zones.

The compression unit 225 may be configured to compress a frame data of the video data into a compressed data in such a manner that at least one frame data preceding a target frame data to be compressed and at least one frame data following the target frame data are used for the compression. Such compression techniques include, for example, MPEG compression and h.264 compression. In MPEG 4 which is a kind of MPEG compression, in order to compress a certain frame, motion compensation using the data of past two frames and future two frames relative to the target frame is used in addition to the discrete cosine transformation and the entropy coding technique to increase the compression rate. If, however, it is more important to avoid a problem associated with a delay of video, it is preferable that the compression unit 225 uses only the preceding frame data without any subsequent frame data to compress a target frame data, though the compression rate will be lowered. When the compression rate is high, a problem associated with a delay of video is less likely to occur even if the time required for compression becomes somewhat long because it takes a shorter time to transmit the compressed data from the video processor 200 to the terminal device 300.

The compression unit 225 in this embodiment is configured to compress a frame data into a compressed data within 200 ms, preferably within 100 ms after the video data receiving unit 223 has received the frame data.

The compression unit 225 may be configured to complete the process of compressing a target frame data into the compressed data before the video data receiving unit 223 starts to receive a frame data incoming three frame data later than 0the target frame data. In the case of video data at 60 fps, a delay time to the end of the compression in this case is 50 ms. In the case of video data at 30 fps, a delay time to the end of the compression in this case is 100 ms.

The compression unit 225 of this embodiment compresses the frame data using JPEG compression, but not limited thereto. The compression rate is lower than that for the MPEG compression, but the compression is completed prominently faster. Even in a prototype machine created by the applicant of the present application, it has already found that the compression unit 225 can compress a frame data into a compressed data within 200 ms, preferably within 100 ms after the video data receiving unit 223 has received the frame data, and can complete the process of compressing the target frame data into the compressed data before the video data receiving unit 223 starts to receive a frame data incoming three frame data later than the target frame data in the case of a video at 60 fps.

The applicant has found that, even in the case where the compression unit 225 performs MPEG compression, the compression unit 225 can compress a frame data into a compressed data within 200 ms, preferably within 100 ms after the video data receiving unit 223 has received the frame data.

The compression unit 225 can apply the following transformation to the header of the compressed data. In JPEG and MPEG compression, header information is attached to data after the compression is performed with an existing technique. In the header information, data such as the type of compression and a reference table required for performing decompression are written according to a standardized rule. The terminal device 300 which has received the compressed data thus needs the data written in the header when it performs decompression of the compressed data. Decompression of the compressed data cannot be completed without it. The compression unit 225 of this embodiment transforms a part of the header information according to a predetermined algorithm, but not necessarily limited thereto. This is for the purpose of allowing only the terminal device 300 having such an algorithm to perform the inverse transformation of the header information of the compressed data to decompress the compressed data. The transformation of the header information may be performed, for example, by reversing the order of the character strings making up of the header information with respect to a part of the header information, dividing the header information into several pieces and changing the order of some pieces, or adding a character as a noise every few characters to at least a part of the character strings making up of the header information, although the size of the data for the header information is increased in the last case. In this embodiment, it is assumed that the aforementioned algorithm executed by the compression unit 225 is set from the time of shipment of the video processor 200, but it can also be set using an input from the input device 202.

The wireless LAN control unit 226 receives numerical values for identifying an IP address and a port number from the operation signal analyzing unit 221 and receives the compressed data from the compression unit 225. The wireless LAN control unit 226 receives the compressed data sequentially transmitted from the compression unit 225, and sequentially transmits the received compressed data to the wireless LAN communication unit.

On the other hand, the wireless LAN control unit 226 sets the IP address received from the operation signal analyzing unit 221 to the wireless LAN communication unit, as described above. The IP address is for identifying the terminal device 300 to which the compressed data is wirelessly transmitted from the wireless LAN communication unit. The IP address can be set according to a known technique. The numerical value set as the IP address can be a known value. In this embodiment, the destination IP address of the terminal device 300 is set to “255.255.255.255”. With this setting, the number of terminal devices 300 that can receive the compressed data is substantially infinite.

On the other hand, the wireless LAN control unit 226 sets the port number received from the operation signal analyzing unit 221 to the wireless LAN communication unit, as described above. The port number is a numerical value for specifying which software installed in the terminal device 300 that has received the compressed data wirelessly transmitted from the wireless LAN communication unit is used to process the compressed data.

The wireless LAN communication unit has a function of transmitting the compressed data received from the wireless LAN control unit 226 to the terminal device(s) 300 by the function of the wireless LAN. The wireless LAN communication unit in this embodiment is configured to transmit the compressed data to the terminal device(s) 300 using Wi-Fi, but not limited thereto. The IP address for specifying the terminal device(s) 300 is “255.255.255.255,” as described above.

Next, the terminal device 300 is described.

Each terminal device 300 is a portable computer.

The terminal device 300 includes a display unit 301. The terminal device 300 also includes an input device 302. The input device 302 can also be formed with a touch panel integrated with the display unit 301, as is well known, rather than physical keys as shown in FIG. 1.

The terminal device 300 has a function of the wireless LAN. The function of the wireless LAN is achieved by a wireless LAN communication unit which is not shown. The wireless LAN in this embodiment is Wi-Fi, but not limited thereto. The wireless LAN communication unit of the terminal device 300 can communicate with the wireless LAN communication unit of the video processor 200.

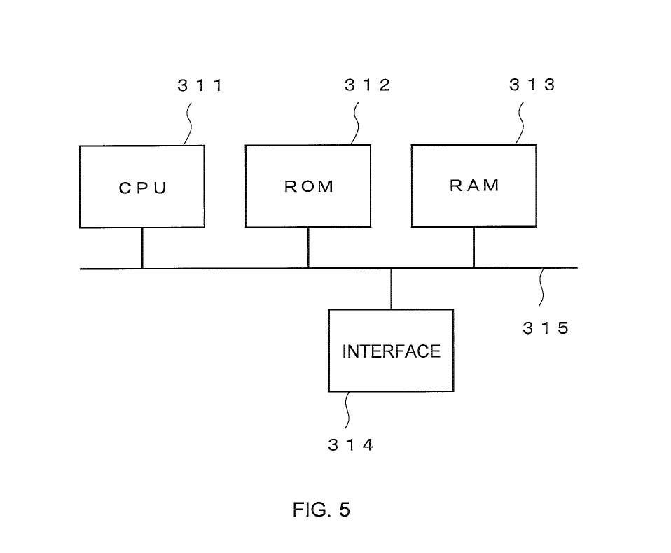

The terminal device 300 has a hardware configuration as shown in FIG. 5.

In this hardware configuration, a CPU 311, a ROM 312, a RAM 313, and an interface 314 are connected to each other via a bus 315. The hardware configuration may include a hard disk drive similar to that provided in the video processor 200.

The functions of the CPU 311, the ROM 312, the RAM 313, the interface 314, and the bus 315 are basically the same as those of the CPU 211, the ROM 212, the RAM 213, the interface 214, and the bus 215, respectively, in the video processor 200.

The ROM 312, however, stores a computer program required for achieving the following processes executed by the terminal device 300. Furthermore, the ROM 312 also stores software required for executing processes for zooming (e.g., by pinching) described later and recording of a display image (e.g., by print screen).

The interface 314 of the terminal device 300 is connected to the aforementioned wireless LAN communication unit mounted in the terminal device 300, and the wireless LAN communication unit receives the compressed data received from the video processor device 200. The interface 314 is connected to the input device 302, and is configured to receive an instruction indicating operation from the input device 302. This instruction indicating operation includes at least designation information described later. The interface 314 is also connected to the display unit 301 and is configured to transmit data for displaying a predetermined display image on the display unit 301.

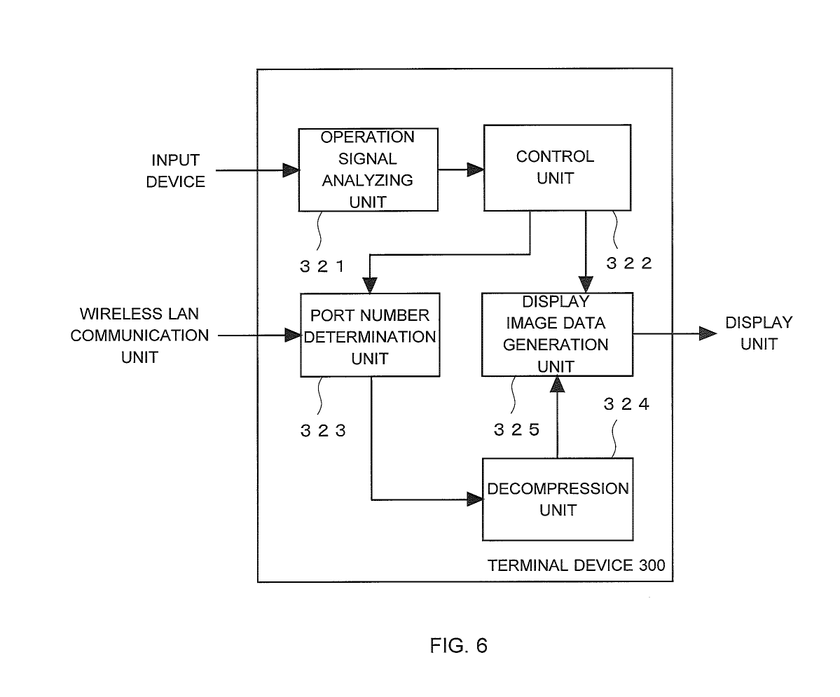

When the CPU 311 executes a computer program, a function block as shown in FIG. 6 is generated inside the terminal device 300. It should be noted that the following functional blocks may be generated by the aforementioned computer program alone, but may be generated by the aforementioned computer program in cooperation with the operating system or other computer program run on the terminal device 300. Furthermore, at least some functions of the following functional blocks may be executed by hardware, not by software.

An operation signal analyzing unit 321, a control unit 322, a port number determination unit 323, a decompression unit 324, and a display image data generation unit 325 are generated inside the terminal device 300.

The operation signal analyzing unit 321 analyzes an operation signal supplied from the input device 302. The operation signal related to this embodiment is designation information. The designation information is for specifying a numerical value which is information for determining a port number which is a numerical value for determining software to process the compressed data received by the terminal device 300 from software installed on the terminal device 300. This numerical value is transmitted to the control unit 322.

The control unit 322 has a function of determining the port number which is a numerical value for determining which software is used to process the compressed data received by the terminal device 300 among software installed on the terminal device 300, when the control unit 322 receives the numerical value from the operation signal analyzing unit 321. This numerical value may be a numerical value itself represented by the operation entered from the operation signal analyzing unit 321, but may be a numerical value obtained as a result of a certain arithmetic operation performed on the numerical value. In this embodiment, as a result of such arithmetic operation, a numerical value for determining software to process the compressed data received by the terminal device 300 among software installed on the terminal device 300. This numerical value is transmitted to the port number determination unit 323.

The port number determination unit 323 is configured to receive, from time to time, headers and compressed data packets transmitted from the wireless LAN communication unit of the video processor 200 and received by the wireless LAN communication unit of the terminal device 300 via the interface 314.

The port number determination unit 323 compares the port number specified by the video processor 200 with the port number received from the control unit 322. If they match each other, the port number determination unit 323 receives the compressed data, and if they do not match, it does not receive the compressed data. The comparison described above may be performed only when the first compressed data may be performed only when the first compressed data is received or at every predetermined time interval such as every 10 minutes. In this embodiment, this process is performed only when the first compressed data is received.

In response to receiving the compressed data, the port number determination unit 323 transmits the received compressed data to the decompression unit 324.

In response to receiving the compressed data from the port number determination unit 323, the decompression unit 324 decompresses the compressed data and restores the frame data from the compressed data. The decompression unit 324 is configured to transmit the frame data obtained by decompressing the compressed data to the display image data generation unit 325.

The decompression unit 324 in this embodiment has an algorithm for performing a so-called inverse transformation for transforming the header information of the compressed data back to the original header information. This is achieved by, for example, installing the software specified by a presenter into the terminal devices 300 owned by listeners. For example, if each presenter designates software, it is possible to select listeners who can view the video(s) that he or she has distributed.

The decompression unit 324 in this embodiment transforms the header information back to the original by the aforementioned inverse transformation, and then decompresses the compressed data using the header information to restore the frame data. A method used to decompressing the compressed data may be a known one.

The decompression unit 324 transmits the frame data to the display image data generation unit 325 from time to time. The display image data generation unit 325 causes the display unit 301 to display an image based on the frame data received from the decompression unit 324. Each time the display image data generating unit 325 receives the frame data, it causes the display unit 301 to display an image based on that frame data.

Next, a method of using this communication system and operations thereof are described.

To use this communication system, a presenter first connects the output terminal of the video output device 100 and the input terminal of the video processor 200 via a cable 100A. In this embodiment, they are connected to each other using an HDMI cable, but not limited thereto.

Besides, either before or after the aforementioned operation, the presenter operates the input device 202 of the video processor 200 to enter a numerical value for determining the port number to the video processor 200, and lets listeners to enter, into their own terminal devices 300, the numerical value for determining the port number for identifying the software used to process compressed data when the terminal device 300 receives the compressed data. The numerical value is transmitted to the listeners by, for example, verbally or by e-mail or the like.

The numerical value supplied from the input device 202 to the video processor 200 is transmitted to the control unit 222 via the operation signal analyzing unit 221. As described above, the control unit 222 of this embodiment determines, as the port number, a numerical value determined after a predetermined arithmetic operation is performed on the numerical value entered by the input device 202. For example, in general, the port number is determined by adding a predetermined numerical value to a default numerical value of 8255. In this embodiment, the presenter operates the input device 202 to enter a numerical value that is equal to the sum of a predetermined numerical value (e.g., 1000) and a numerical value (e.g., 10) that listeners who are allowed to receive and decompress compressed data on their own terminal devices 300 should enter into their own terminal device 300, of 8255 plus the predetermined numerical value (e.g., 1000) plus the numerical value (e.g., 10) that listeners who are allowed to receive and decompress compressed data on their own terminal devices 300 should enter. The control unit 222 determines the numerical value of 9265 obtained by summing them as the port number, and transmits this numerical value to the wireless LAN control unit 226.

On the other hand, in this embodiment, a sum of 8255 and a predetermined numerical value (e.g., 1000) is included in advance in the computer program installed on the terminal devices 300 of the listeners, and a numerical value entered when a listener operates his or her input device 302 is added to the sum by the control unit 322. The 8255+ the predetermined numerical value (e.g., 1000) is determined without being known by the audience/listeners. The presenter notifies a correct numerical value (which is, for example, 10 as described above) that each listener should enter only to participants of the presentation who are allowed to receive and decompress compressed data to view intended videos. Only the terminal devices 300 of the listeners who know the notified correct number can obtain the correct port number. As described above, since a predetermined numerical value (e.g., 1000) which is not seen from the audience/listeners is used for determining the port number in addition to the numerical value of the default port number of 8255, it is hard for a malicious third party to know the correct port number.

In the video processor 200, the determined port number is transmitted from the control unit 222 to the wireless LAN control unit 226.

In the terminal device 300, the port number is transmitted from the control unit 322 to the port number determination unit 323.

In addition, the presenter enters, with the input device 202, a numerical value for specifying the IP address of the terminal devices 300. The numerical value is transmitted from the operation signal analyzing unit 221 via the control unit 222 to the wireless LAN control unit 226. Here, it is assumed that the IP address of each terminal device 300 is set to “255.255.255.255”. It is also possible to set such an IP address as a default and omit the input by the presenter.

In this state, the presenter starts his or her presentation.

When the presenter operates the input device 102, the video output device 100 executes known software for presentation. An image based on the execution result is displayed on the display unit 101 of the video output device 100. It is assumed that this image contains a video at least on a part of the screen in at least a certain time period.

The video data which is data on the image displayed on the display unit 101 is transmitted from the output terminal to the input terminal of the video processor 200 via the cable 100A.

The following processes in the video processor 200 are performed basically in an automatic manner.

A video data including a large number of consecutive frame data supplied from the input terminal is transmitted to the image data processing unit 224. The image data processing unit 224 performs the aforementioned necessary processes on the frame data. For example, it superimposes data of copyright indication on each frame data, and transmits it to the compression unit 225.

The compression unit 225 compresses the frame data every time it receives the frame data, and performs the aforementioned transformation on the header information of the generated compressed data. The compression unit 225 transforms a target frame data into compressed data within 200 ms, preferably within 100 ms after the video data receiving unit 223 has received that target frame data. Alternatively, the compression unit 225 completes the process of compressing the target frame data into the compressed data before the video data receiving unit 223 starts to receive a frame data incoming three frame data later than the target frame data.

The compression unit 225 transmits the compressed data to the wireless LAN control unit 226 each time it generates the compressed data.

The wireless LAN control unit 226 divides the compressed data into packets and adds headers to the heads of the packets. To the header, its own IP address, capacity information which is information indicating the capacity of compressed data to be transmitted, and the aforementioned port number are written. Packets for these headers and a large number of compressed data are transmitted to the wireless LAN communication unit and are, in turn, transmitted from the wireless LAN communication unit to each terminal device 300.

Since the video processor 200 itself has the wireless LAN communication unit and serves as an adhoc base station, communication with the terminal device 300 can be achieved with a simple network without any other transmission device such as a wireless router.

A series of packets associated with the compressed data with the header located at the head are received by the wireless LAN communication unit of the terminal device 300. If the IP address is set as described above, the number of terminal devices 300 is not limited. The data received by the terminal devices 300 are transmitted to the port number determination unit 323.

In response to receiving these data, the port number determination unit 323 reads the port number written in the header. The port number determination unit 323 compares the port number written in the header of the packets of the compressed data with the port number transmitted from the control unit 322. When these numerical values match, the port number determination unit 323 transmits the packets of the compressed data received by the terminal device 300 to the decompression unit 324. If the numerical values of the two port numbers do not match, no subsequent process is performed on that terminal device 300.

In response to receiving the compressed data from the port number determination unit 323, the decompression unit 324 first performs the aforementioned inverse transformation on the header information to restore the header information to the original. Then, the decompression unit 324 decompresses the compressed data using the restored header information to restore the original frame data. The decompression unit 324 transmits the frame data obtained by decompressing the compressed data to the display image data generation unit 325.

The display image data generation unit 325 displays an image based on the frame data received from the decompression unit 324 on the display unit 301 every time the frame data is received. As a result, on the display unit 301, a video that can be deemed to be substantially identical to the one displayed on the display unit 101 of the video output device 100 is displayed with little delay.

The audience can listen to the presentation provided by the presenter while watching the images displayed on the display unit 301 of the terminal device 300. This eliminates paper handouts for presentation, which otherwise would be necessary.

If an image is difficult to see due to, for example, small characters displayed on the image, a listener can pinch and zoom the image if the terminal device 300 has such a function to recognize these small characters clearly. The listener can also zoom a part of the display image to which he or she wants to pay particular attention.

In addition, while watching the image(s) displayed on the display unit 301, the listener can save a part of the data of the image in, for example, the RAM 313 of the terminal device 300 using a function of saving screenshot such as print screen if the terminal device 300 is equipped with this, at the time when the image desired to be stored is displayed on the display unit 301. This makes it less and less necessary to distribute paper handouts.

Recently, most smartphones and the like which are expected to be used as the terminal device 300 are provided with functions of zooming and saving display images, but at least one of these functions can be included in a computer program for causing the computer according to the present invention to function as the terminal device 300.

In the image, all frames contain the aforementioned character(s) indicating that the video is protected by copyright. Accordingly, it is unlikely that a person who saved a video or a still image captured from the video in the terminal device 300 misuses it.

In this embodiment, the process of superimposing data of an image such as characters on the frame data is performed by the video processor 200. Such process, however, can be performed by the terminal device 300. In such a case, data of an instruction to cause the terminal device 300 to execute the process of superimposing data of an image such as characters on the frame data is transmitted from the video processor 200 to the terminal device 300. The terminal device 300 executes the process in accordance with the received instruction based on the data of the instruction. The data of this instruction is to write such characters in each frame. That is, the data of the instruction is basically made up of a combination of image information for identifying characters of each frame and an instruction to write the characters identified by the information in each frame. However, when the characters to be written in the frame data are predetermined, the following may apply. When the character is a single character, the data of the instruction may be an instruction to write that single character in each frame. When the characters are two or more different characters, the data of the instruction may be a combination of data for use in selecting characters from different characters and an instruction to write the selected characters in each frame. The transmission of the data of the instruction may be performed only once when the transmission of the compressed data from the video processor 200 to the terminal device 300 is started, or two or more times at appropriate timing. Alternatively, it may be performed every time the compressed data is transmitted. The aforementioned data of the instruction may be generated by the control unit 222 in accordance with an input from the input device 202, and may be transmitted to the terminal device 300 via the wireless LAN control unit 226. It should be noted that how the terminal device 300 executes the process of superimposing the data of an image such as characters on frame data can be determined arbitrary. Any of the aforementioned processes 1 to 3 that can be executed by the video processor 200 can be applied to this, depending on the hardware configuration of the terminal device 300.

### Second Embodiment

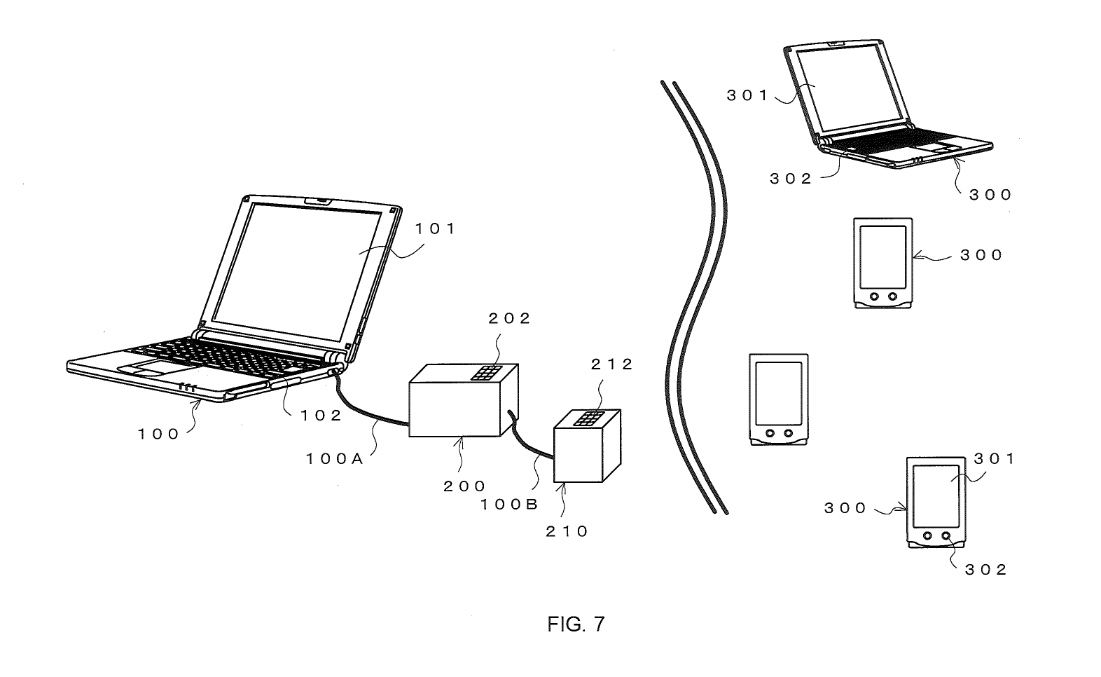

FIG. 7 shows a communication system according to a second embodiment.

This communication system is almost identical to that described in the first embodiment. The video output device 100 and the terminal device 300 are the same as those described in the first embodiment.

The difference between the communication system of the second embodiment and the communication system of the first embodiment lies in the following. The video processor 200 of the first embodiment has the built-in wireless LAN communication unit, while the video processor 200 of the second embodiment has no built-in wireless LAN communication unit. A wireless router 210 connected to the video processor 200 through a predetermined cable 100B is the counterpart of the wireless LAN communication unit in the second embodiment.

In the second embodiment, compressed data generated by the compression unit 225 are sequentially transmitted to the wireless router 210 via the cable 100B. The wireless router 210 sequentially transmits the received compressed data to the terminal device 300 in the same way as the wireless LAN communication unit sequentially transmits the compressed data to the terminal device 300 in the first embodiment.

In the first embodiment, the wireless LAN control unit 226 that controls the wireless LAN communication unit is provided in the functional blocks. In the second embodiment, this may be provided either in the video processor 200 or in the wireless router 210. If the wireless LAN control unit 226 is provided in the wireless router 210, the wireless router 210 is provided with the input device 212, and some functions of the operation signal analyzing unit 221 and the control unit 222 are also provided in the wireless router 210. A numerical value for determining the port number and a numerical value for specifying the IP address of the terminal device 300 can thus be entered from the input device 212.

1. A video processor used in combination with a video output device for outputting a video data via a line, the video data being a data of a video comprising a large number of frame data, each frame data being data of each of continuous sequence of frames, the video processor comprising:
receiving means for receiving a video data supplied from the video output device;
compression means for executing a process of compressing data of each frame in the video data received by the receiving means into compressed data in a digital format; and
output means for sequentially supplying the compressed data generated by the compression means to a transmission device having transmission means for transmitting the compressed data to a terminal device via communication with a wireless LAN.

2. The video processor according to claim 1, wherein the video processor is formed as a single unit having the transmission device by comprising the transmission means.

3. The video processor according to claim 1 or 2, wherein the compression means compresses each of the frame data of the video data received by the receiving means, as a single still image without any other processing.

4. The video processor according to claim 3, wherein the compression means performs JPEG compression.

5. The video processor according to claim 3, wherein the compression means is configured to compress a portion of each of the frame data in the order of being received from the receiving means.

6. The video processor according to claim 1 or 2, wherein the compression means is configured to compress the frame data of the video data received by the receiving means into the compressed data by using at least one of frame data preceding the frame data to be compressed and frame data following the frame data to be compressed.

7. The video processor according to claim 6, wherein the compression means performs MPEG compression.

8. The video processor according to claim 3 or 6, wherein the compression means is configured to complete the process of compressing a target frame data into the compressed data before the receiving means starts to receive a frame data incoming three frame data later than the target frame data.

9. The video processor according to claim 3 or 6, wherein the compression means is configured to complete the process of compressing the frame data into the compressed data before the expiration of 200 ms after the receiving means has received the frame data.

10. The video processor according to claim 9, wherein the compression means is configured to complete the process of compressing the frame data into the compressed data before the expiration of 100 ms after the receiving means has received the frame data.

11. The video processor according to claim 2, wherein the transmission means is configured to transmit the compressed data to the terminal device using UDP/IP protocol.

12. The video processor according to claim 2 or 11, wherein the transmission means has a setting of “255.255.255.255” as a destination IP address of the terminal device.

13. The video processor according to claim 2 or 11, wherein the transmission means is configured to arbitrarily set a port number for specifying software to process the compressed data received by the terminal device from software installed on the terminal device,
and the video processor comprises port number input means for inputting information to set the port number; and
only the terminal device for which the same port number set on the transmission means has been set is able to display a video based on the received compressed data.

14. The video processor according to claim 1 or 2, wherein the compression means is configured to generate the compressed data as having header information and be able to transform at least a portion of the header information according to a certain algorithm, and wherein
only the terminal device being able to perform inversion of the transformation of the header information is able to display a video based on the received compressed data.

15. The video processor according to claim 1 or 2, comprising modification means for modifying the frame data in such a manner that at least one of a certain character, symbol, and glyph is overlapped with an image represented by the frame data.

16. The video processor according to claim 2, comprising instruction addition means, the instruction addition means adding modification instruction data to the compressed data transmitted from the transmission means to the terminal device and allowing the transmission means to transmit the compressed data, the modification instruction data being for causing the terminal device to execute a process of modifying the frame data in such a manner that at least one of a certain character, symbol, and glyph is overlapped with an image represented by the frame data.

17. A video processing method executed on a video processor used in combination with a video output device for outputting a video data via a line, the video processor comprising a computer, the video data being a data of a video comprising a large number of frame data, each frame data being data of each of continuous sequence of frames,
the video processing method comprising performing, with the computer:
a receiving operation for receiving the video data outputted from the video output device;
a compression operation for compressing data of each frame in the video data received by the receiving operation into compressed data in a digital format; and
an output operation for sequentially outputting the compressed data generated by the compression operation to a transmission device having transmission means, the transmission means transmitting the compressed data to a terminal device via communication with a wireless LAN.

18. A computer program causing the computer to function as a video processor used in combination with a video output device for outputting a video data via a line, the video processor including a computer, the video data being a data of a video comprising a large number of frame data, each frame data being data of each of continuous sequence of frames, the computer program causing the computer to execute:
a receiving operation for receiving the video data supplied from the video output device;
a compression operation for compressing data of each frame in the video data received by the receiving operation into compressed data in a digital format; and
an output operation for sequentially outputting the compressed data generated by the compression operation to a transmission device having transmission means, the transmission means transmitting the compressed data to a terminal device via communication with a wireless LAN.
